(19) United States
(12) Patent Application Publication
(10) Pub. No.: US 2012/0085483 A1
(43) Pub. Date: Apr. 12, 2012

(54) Method and Apparatus for Running Short Orders on the Wet End of a Corrugator

(75) Inventor: James A. Cummings, Phillips, WI (US)

(73) Assignee: Marquip, LLC, Phillips, WI (US)

(21) Appl. No.: 13/270,550

(22) Filed: Oct. 11, 2011

Related U.S. Application Data
(60) Provisional application No. 61/392,207, filed on Oct. 12, 2010.

(51) Int. Cl. B65H 69/06; B31F 5/00

(52) U.S. Cl. 156/157; 156/504

(57) ABSTRACT

Method and apparatus for operating a corrugator wet end splicing of three short orders between a longer first order and a longer fifth order utilizes a primary splicer and a tandem splicer in which the first two short order webs from paper rolls on the tandem splicer can be prepared for splice while the first longer order is running by threading the first of the short order webs from the tandem splicer to the primary splicer for splice preparation on the primary splicer and preparing the second short order for splice on the tandem splicer. The first and second short order webs are spliced on the primary and tandem splicer, respectively, immediately after completion of the longer first order. The third short order web is provided by a fourth roll mounted on the roll stand for the primary splicer immediately after completion of the longer first order.

### CROSS REFERENCE TO RELATED APPLICATION

This application relates to and claims priority from U.S. Provisional Application Ser. No. 61/392,207 filed on Oct. 12, 2010.

### FIELD OF THE INVENTION

The present invention relates to the production of corrugated board and more particularly to a novel method for loading and threading-up paper rolls on the corrugator to facilitate the running of very short wet end orders.

### BACKGROUND

Single wall corrugated board is comprised of three layers of paper including a top liner, a fluted medium and a bottom liner. The strength of the corrugated board is defined by an edge crush test (ECT) that is closely correlated with the strength of these papers. Paper strengths are commonly measured using a short span compression test (STFI). The corrugated board ECT can be estimated using a relationship that is a linear combination of the STFI's of the papers and the take up factor of the fluted medium. The STFI of the papers is primarily determined by the fiber content measured in pounds per thousand square feet or grams per square meter. The paper grades used in the formation of the corrugated board, as a consequence, determine the strength of the box produced.

Corrugated boxes manufactured using single wall board are frequently used to ship products by air, truck or rail. Freight carriers imposed packaging rules in exchange for accepting liability for the integrity of the contents of the goods transported. These rules were codified by the National Motor Freight Carriers Item 222 and the National Railroad Freight Committee Rule 41. These rules determined packaging material specifications that varied depending upon the gross weight of the package and the box dimensions. The specifications dictated box liner and medium combined basis weights. In 1990, trade associations for the corrugated industry sponsored proposals to eliminate Item 222 and Rule 41 and allow use of ECT instead of traditional paper basis weights as the primary specification for box design. These changes, when approved, gave the corrugated producers considerable more flexibility in the design of corrugated boxes that took the end users performance requirements into consideration.

In response to this change, the paper manufacturers developed a variety of liners and mediums with enhanced STFI to further expand the options for paper grades available to the corrugated producers. Since fiber content represents approximately 80% of the cost of producing a box, there was strong focus on use of specific paper combinations to just match customer ECT requirements. The end result of this development was a significant increase in the number of paper changes on the wet end of the corrugator. Along with the concurrent trend of just-in-time manufacturing, this has resulted in as many as 80 paper changes or more per shift on some sheet feeder corrugators.

Minimum length of a wet end order is normally determined by the time that it takes to change a paper roll and prepare it for a splice. This cycle begins when a paper butt roll is spliced out. The butt roll is removed from the corrugated and then a new paper roll powered on a track and trolley system beneath the corrugator. The paper must then be prepared for a splice. Papers are normally changed at the top liner, medium and bottom linear roll stand positions. These tasks can be conducted in parallel with adequate crew on the corrugator. Nonetheless, with four minute paper roll changeover and splice preparation and corrugator speed slowed to 500 FPM, the minimum order length on the wet end of the corrugator is 2000 lineal feet. Certain customers for sheet feeder corrugators would like orders shorter than 500 lineal feet.

One way of achieving short orders is to avoid width and paper grade change by either taking extra wide trim to avoid width change or to upgrade the basis weight of the papers run to avoid a paper grade changes. Both of these options create substantial fiber loss since the customer will not accept an upcharge for wasted trim or heavier grade papers used.

U.S. Pat. No. 6,575,217 discloses a technique for quick paper change that involves the addition of single sided roll stands that allow up to four rolls to be chucked up on the corrugator that are operationally related to one splicer. This idea allows the process of splice preparation and roll change to occur in an overlapped fashion to reduce wet end order change cycle times. The technique requires substantial space in-line in the corrugator to accommodate the extra roll stands. For existing corrugators, this would require very signification relocation of equipment and, in the vast majority of cases, is impractical because of building constraints and cost.

As a consequence, there is a need in the corrugated industry for a means of facilitating short orders on the wet end of the corrugator.

### SUMMARY

The method of the present invention involves use of tandem splicer/roll stands that allow paper rolls associated with two sequential next-up paper changes to be loaded and prepared for splice while running paper from rolls currently chucked upon on adjacent primary splicer/roll stands. A typical order change made using the method of the present invention would involve paper change at the top liner, medium and bottom liner positions. The chuck-up of these future wet end paper rolls in parallel with the current running of a longer order allow two future order changes to be made with simple splice initiation.

To accomplish this, the papers from the rolls chucked-up on the tandem splicer/roll stands are threaded through the tandem splicers, down around auxiliary splice preparation platforms and then through the splicer carriages available on the upstream end of the primary splicers where the papers are prepared for splice. After splice preparation is complete, the auxiliary splicing platforms can be either manually removed or raised to a higher running level position allowing yet future wet end paper rolls to be run beneath the corrugator and chucked-up on the upstream ends of the primary splicer/roll stands. This done, the corrugator has three future order paper types loaded onto the roll stands in anticipation of wet end order changes.

Splicing of a roll mounted on the tandem splicer/roll stand with use of a splicer carriage of the primary splicer/roll stand involves intermodal splicing. Intermodal splicing uses the splicer carriage functions of stop bar, cutoff knife and splice sealing rolls on the primary splicer/roll stand and the paper roll accelerating functions of the capstan roll, dancer system and brake control on the tandem splicer/roll stand. The intermodal splicing idea is the key concept of the present invention that allows a roll chucked on the tandem splicer to be spliced into a roll located on the primary splicer. Once this is done, then a further wet end paper can be spliced onto the tail of the next order at order change using the normal splice cycle of the tandem splicer.

Normally, minimum length of a wet end order is determined by the cycle time associated with splicing and changing out a butt roll and then loading and chucking-up a new roll and preparing this roll for splice. However, with the tandem splicer/roll stand concept of the present invention using intermodal splicing, the minimum length of the first and second orders ahead can be cut in half because these two orders are ready to run with simple push of a splice activate button. The time available to change out the roll on the downstream end of the primary splicer/roll stand that will become the third order ahead is equal to the duration of running two wet end orders instead of one. The fourth order ahead would become the roll chucked-up on the upstream end of the primary splicer. Since this roll must only be prepared for a splice during the running of the third order ahead, this third order ahead can also be a short order.

The tandem splicer/roll stand of the present invention requires that two splicer/roll stand pairs be available on each side of a single facer as well as at the bottom liner position. Most corrugators have at least two single facers to allow the manufacture of double wall board. A typical corrugator will run with one single facer making single wall board more than 85% of the time. For various reasons, the upstream single facer is normally the most used. With the advent of single facers with quick cassette change, it is possible to rim nearly all single face board on the most upstream single facer. Using the most upstream single facer allows the top liner splicer/roll stand on the downstream single facer to be used as the tandem splicer/roll stand for short order set-up on the medium side of the upstream single facer. Similarly, the medium splicer/roll stand on the downstream single facer can become the tandem splicer/roll stand for the double backer or bottom liner position. This means that only one additional splicer/roll stand must be added at the most upstream end of the typical corrugator to run short wet end orders with the tandem splicing concept of the present invention. There is space at the end of most corrugators to install another splicer/roll stand that would become the tandem splicer/roll stand for the top liner paper on the upstream single facer. Of course, on a new corrugator, tandem splicer/roll stands could be factored into the design to alleviate some of the considerations noted.

Features and advantages of the tandem splicer/roll stand concept with intermodal splicing will become apparent from the following description of the preferred embodiment considered along with the accompanying drawings.

### BRIEF DESCRIPTION OF THE DRAWINGS

FIG. 1 is a schematic side elevation view of a conventional corrugator wet end.

FIG. 2 is a schematic top plan view of a section of a corrugator wet end.

FIG. 3 is a schematic side elevation view of a corrugator with extra tandem splicer/roll stand on the upstream end of the corrugator.

FIG. 4 is a schematic side view of tandem and primary splicer/roll stands showing thread-up of a paper roll on a tandem splicer/roll stand around the auxiliary splicing platform and through the splicer carriage of the primary splicer.

FIG. 5 is a schematic side view of a tandem and primary splicer/roll stand showing the auxiliary splicing platform in the run position and a new roll chucked up in the upstream roll stand position of the primary splicer.

FIG. 6 is a schematic side view of a tandem and primary splicer/roll stand showing the downstream roll of the tandem splicer/roll stand running and the downstream paper butt roll removed from the primary roll stand.

FIG. 7 is a schematic side view of a tandem and primary splicer/roll stand with a new roll chucked up and prepared for splice on the downstream position on the primary roll stand and the upstream roll on the tandem splicer running.

FIG. 8 is a schematic side view of a tandem and primary splicer/roll stand with the new downstream paper roll on the primary splicer/roll stand spliced in and running and the upstream paper roll of the primary splicer prepared for a splice.

FIG. 9 is a schematic side view drawing of a tandem and primary splicer/roll stand with the upstream roll on the primary splicer spliced and running.

### DETAILED DESCRIPTION OF THE INVENTION

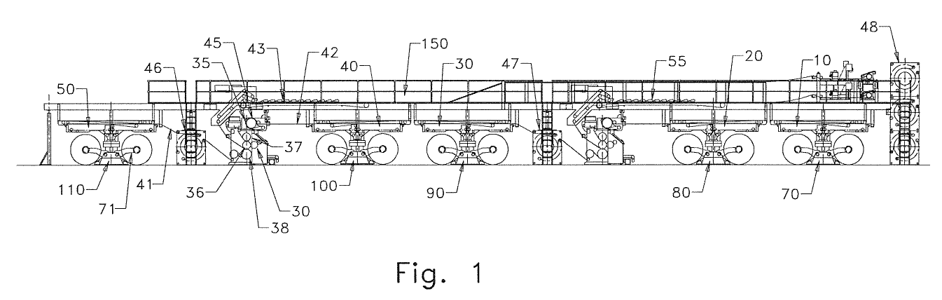

Primary and essential elements of the wet end of a corrugator are shown in FIG. 1. The corrugator wet end 150 uses a single facer 35 located on the upstream end for the purpose of bonding the top liner 41 of the corrugated board to the medium 42. For purposes of continuing the production, the top liner 41 is unwound from the paper rolls mounted on a dual position roll stand 110 with a splicer 50 normally located immediately above that has the function of attaching the tail of a paper web expiring from one roll position to the prepared leading edge of a paper web unwound from the adjacent roll position. Detailed splicer operation is found, for example, in U.S. Pat. No 7,938,925, which is incorporated by reference herein.

A dual position roll stand 110 is located on the upstream side of single facer 35 for the top liner paper 41 and another dual position roll stand 100 is located on the downstream side of single facer 35 for the medium paper web 42. The medium paper 42 is unwound from one end of the dual position roll stand 100 through web splicer 40 and into single facer 35. The single facer normally has associated with it a means of heating and preconditioning the medium paper 42 with a steam shower 45 to soften the fibers so that the medium can be fluted between corrugating rolls 36. As the fluted medium web 42 exits the labyrinth 37 between the corrugating rolls 36, it is retained in a fluted fashion on one of the corrugating rolls 36 using either a vacuum or a pressure technique. A glue roll 39 contained within single facer 35 is located in close proximity to the corrugating rolls 36 and applies an adhesive to the medium flute tips. At this point, the glued flute tips of the medium 42 are pressed against the top liner 41 using a pressure roll 38 where a green bond is quickly formed creating the single face web 43. The top liner 41 enters the single facer 35 from the upstream side. The top liner is normally heated on a preheater 46 located between the top liner splicer 50 and the single facer 35. As the glued medium flute tips are pressed against the top liner 41, the latent heat in the liner continues to cure the bond as it transits down the wet end of the corrugator 150.

A second single facer 55 on the corrugator wet end 150 allows flutes of a different profile to be run. As such, the FIG. 1 corrugator wet end 150 configuration from upstream end toward the downstream end is comprised of top liner roll stands 110 and splicer 50, a preheater 46, a single facer 35, a medium roll stand 100 and splicer 40, a second top liner roll stand 90 and splicer 30 associated with the second single facer 55, another medium roll stand 80 and splicer 20, a final roll stand 70 and splicer 10 for the bottom liner and a triple stack preheater 48 for the bottom liner and single face webs associated with the single facers.

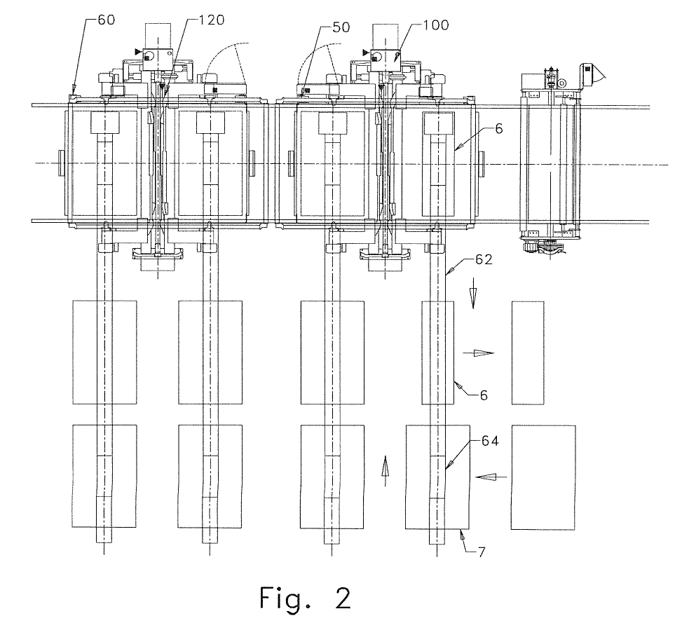

Because of space constraints, many corrugators are located against one side of a factory wall as shown in FIG. 2. Paper rolls must be presented for use on the operating side of the corrugator. Butt rolls remaining after a splice must also be removed from the operator side of the corrugator. This makes for a busy and congested operating space. A typical sequence of events at one position for a paper change begins with the splice out of paper roll 6. This remaining butt roll must then be removed from the roll stand 70. The roll stand arms 71 must be lowered and the butt of paper roll 6 deposited on roll trolley 61 that is positioned beneath the paper roll. Roll stand aims 71 are then raised to allow clearance for the butt roll 6 to be backed out beneath the splicer on roll track 62. The trolley 61 is powered at a slow speed, constrained by safety considerations, out from beneath the corrugator to an unload position 63. The operator then pushes butt roll 6 off the trolley to one side. The trolley 61 is then relocated to the new roll pick up position 64. A new roll 7 is prepped by removing any paper damaged by roll handling and then rolled up onto trolley 61. The trolley 61 is then powered at slow speed back beneath the corrugator wet end 150. Roll stand arms 71 are lowered and paper roll 7 is chucked up. The roll is then raised slightly off the trolley so that it can be rotated freely on the chucks associated with the roll arms 71. At this time, the carriage of the splicer 110 can be positioned for splice preparation. Splice preparation involves threading the paper to be spliced through the splicer carriage, applying splice tape, cutting off the excess paper, cutting lead-ins on the edge of the paper, removing the splice tape backing and indexing the prepared leading edge of the web for splice.

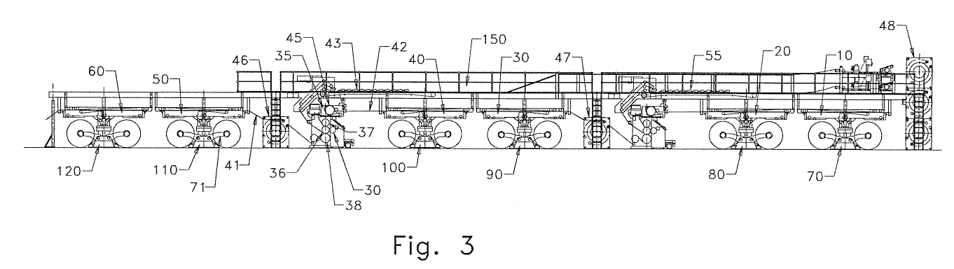

The time to remove a butt roll from beneath the corrugator, reposition a new roll and prepare it for splice along with the corrugator speed are the variables that determine the minimum length of a wet end order. The present invention seeks to eliminate the roll change time completely for two orders ahead by using a tandem splicer. FIG. 3 shows the addition of a sixth splicer 60 at the upstream end of the corrugator wet end 150. Splicer 60 and splicer 50 are the tandem and primary splicers for the top liner 41 for single facer 35. Splicer 30 and splicer 40 are the tandem and primary splicers for the medium 42 for single facer 35, and splicer 20 and splicer 10 are the tandem and primary splicers for the bottom liner 44. This allows short orders to be run for all three papers of single wall board when using single facer 35 as will be explained below.

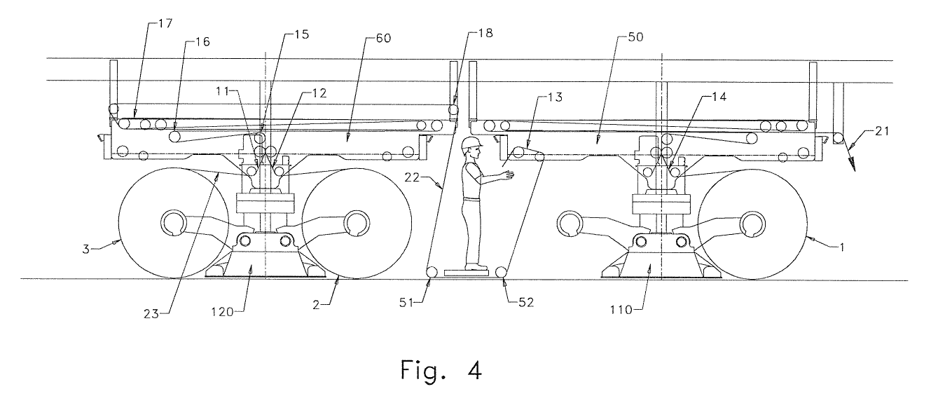

The short order change technique of the present invention will be described for one set of tandem splicer/roll stands 60, 120 and primary splicer/roll stands 50, 110, the technique being identical for all paper positions. The process begins as shown in FIG. 4. Paper roll 1 is currently running on roll stand 110 with the paper web 21 directed through the output of primary splicer 50 as a long running first order. This long run will provide time to charge the tandem roll stand 120 and splicer 60 with new paper rolls for future short orders. Paper roll 2 for the second order is chucked up on the downstream end of tandem roll stand 120 and paper roll 3 for the third order in the sequence is chucked up on the upstream end of roll stand 120. Paper 23 from paper roll 3 is prepared for splice and is in the ready to splice position on upstream splicer carriage 11 of tandem splicer 60. Paper 22 from paper roll 2 is threaded through splicer carriage 12 of tandem splicer 60, around center idler roll 15, capstan roll 16, dancer system 17 and outboard idler roll 18. It is then pulled down around a pair of idler rolls 51 and 52 carried on an auxiliary splice preparation platform 19 and then up through splicer carriage 13 of primary splicer 50 where it is prepared for splice.

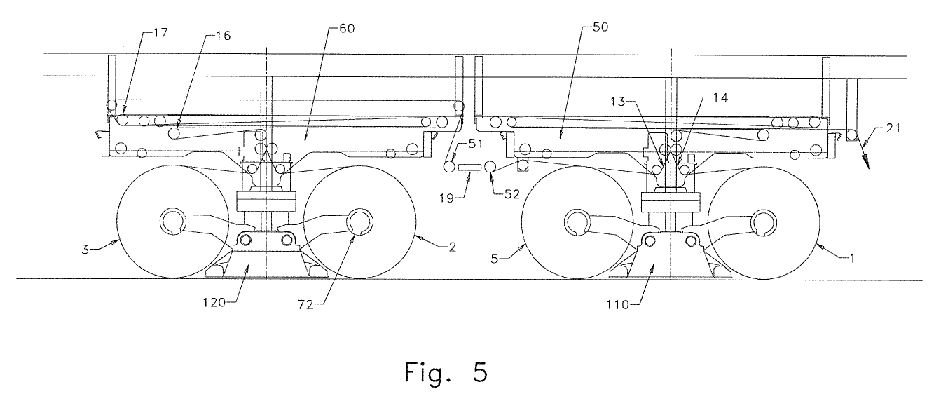

FIG. 5 shows the next step in the set up for short order change. Auxiliary splice preparation platform 19 is shown raised to the run position. Splicer carriage 13 of primary splicer 50 has been powered into the ready to splice position and a new paper roll 5 has been chucked up on the upstream position of roll stand 110. This has all been done while running the long order off paper roll 1. At the completion of these steps, the corrugator is now set up to run up to three very short orders sequentially.

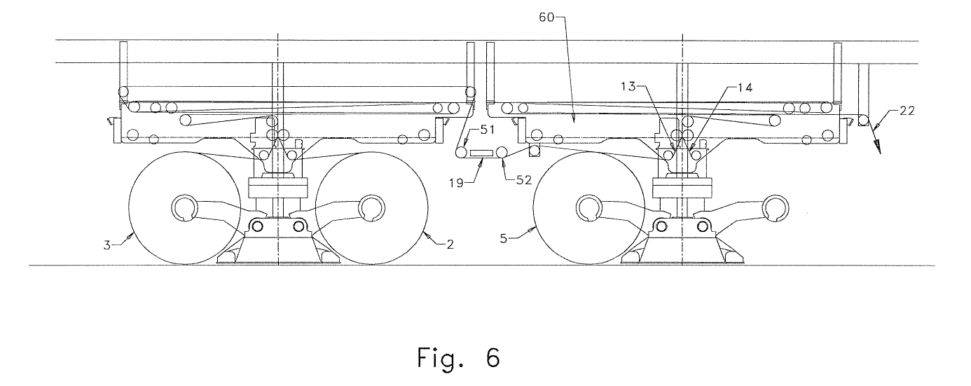

The short order sequence begins, as shown in FIG. 6, with splice of paper roll 2 using a conventional splicer control operative to affect an intermodal splicing technique. A conventional splicer control is disclosed in U.S. Pat. No. 4,170,506, which is incorporated by reference herein. Intermodal splicing uses splicer carriage 13 and splicer carriage 14 of primary splicer 50, and the capstan 16, dancer system 17 and brake control system 72 of tandem splicer 60. The splice is initiated on splicer 50. Splicer carriage 14 stops the paper 21 from paper roll 1. The splice sealing nip rolls 26 of splicer carriage 13 and splicer carriage 14 come together and splicer carriage 14 severs the paper 21. The intermodal splicing control then causes the brake 72 on paper roll 2 of roll stand 120 to be released and capstan roll 16 to be powered up causing acceleration of paper roll 2 up to corrugator speed while dancer system 17 feeds paper 22 to the corrugator process. FIG. 6 shows paper roll 1 removed from the corrugator and splicer carriage 14 of primary splicer 50 backed out to the splice preparation position. Paper 22 from paper roll 2 is spliced and running. As soon as the dancer roll system 17 of tandem splicer 60 accumulates, it is possible to initiate a splice of paper roll 3 to paper roll 2 on tandem splicer 60.

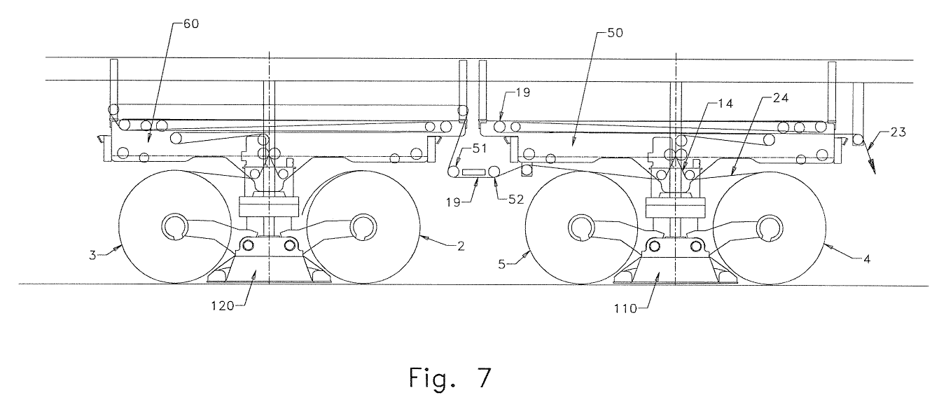

FIG. 7 shows paper 23 from roll 3 spliced and running and a new paper roll 4 chucked-up in the downstream end of primary splicer roll stand 110 and prepared to splice with splicer carriage 14 on splicer 50. Removal of butt roll 1 and placement of paper roll 4 as well as preparation of paper 24 from roll 4 for splice occur during running of the first two short orders from paper roll 2 and paper roll 3.

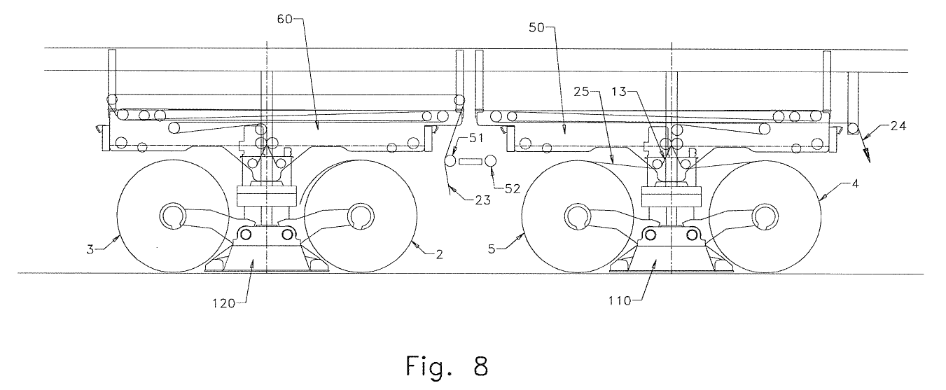

FIG. 8 shows paper 24 from roll 4 spliced and running. Paper 25 from paper roll 5 has been prepared for splice on splicer carriage 13 of primary splicer 50. The order associated with paper roll 4 could also be quite short as it was only necessary to prepare the splice on paper 25 of paper roll 5 after splice of paper roll 4 so that paper roll 4 could be spliced out and paper roll 5 spliced in.

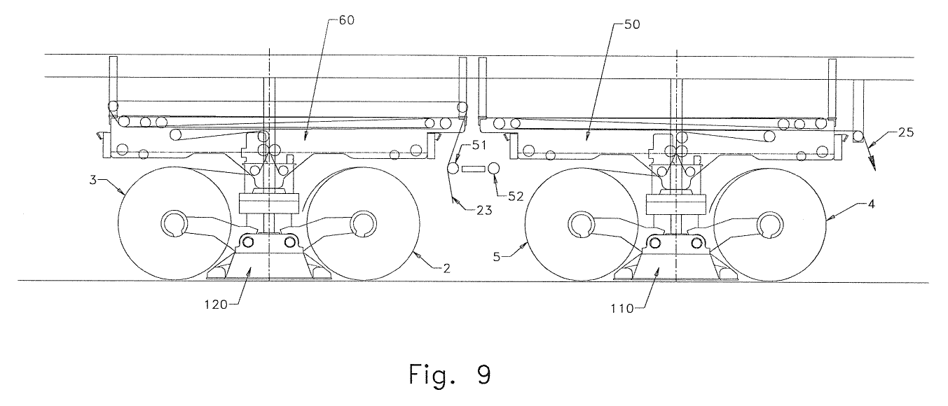

FIG. 9 shows paper 25 from roll 5 spliced and running. This process could now be repeated after splicing paper roll 5 to a new roll that would be chucked up at the downstream end of primary roll stand 110. The order lengths associated with running orders from paper roll 2 and paper roll 3 would be less than half of the standard minimum order length. The order length from running paper 4 could be very short as well, as only a quick splice preparation of paper 25 from paper roll 5 has to occur.

While the invention has been described with reference to a preferred embodiment, those skilled in the art will appreciate that certain substitutions, alterations and omissions may be made without departing from the spirit thereof. Accordingly, the foregoing description is meant to be exemplary only and should not be deemed limitative on the scope of the invention set forth with the following claims.

What is claimed is:

1. A method for facilitating a sequence of three short orders on the wet end of a corrugator, said corrugator wet end including a primary splicer and associated roll stand, a tandem splicer and associated roll stand located immediately upstream of the primary splicer, each roll stand having pairs of upstream and downstream arms, with each splicer containing two splicer carriages, such carriages capable of being positioned at respective opposite ends of the splicer for splice preparation and the carriages operable together in a central position for splicing, and providing a pathway including an auxiliary splice preparation platform between the splicers for routing a paper web from the roll stand for the tandem splicer through the output end of the tandem splicer and into the carriage positioned at the upstream end of the primary splicer, the pathway not interfering with the operator's ability to prepare a splice at the upstream end of the primary splicer, the method comprising the steps of:
(1) chucking-up a first roll on the roll stand arms at the downstream end of the primary splicer and threading a first paper web from the first roll through the downstream splicer carriage and related apparatus and rollers within the primary splicer with the first paper web from the output of the primary splicer feeding an ongoing wet end corrugator process associated with a longer first order;
(2) while feeding the first paper web from the first paper roll, chucking up a second paper roll associated with the second order on the roll stand arms at the downstream end of the tandem splicer and threading a second paper web from the second roll:
through the downstream splicer carriage of the tandem splicer, then
through related apparatus and rollers within the tandem splicer to the output end of the tandem splicer, then
through the auxiliary splice preparation platform, then
through the upstream splicer carriage of the primary splicer positioned at the splice preparation position;
(3) preparing the lead edge of the second paper web from the second roll for a splice on the upstream splicer carriage of the primary splicer while in the splice preparation position with transition of this splicer carriage to the ready to splice position in the primary splicer; and
(4) chucking-up a third paper roll associated with the third order on the roll stand arms at the upstream end of the tandem splicer, threading a third paper web from the third roll through the upstream splicer carriage of the tandem splicer positioned at the splice preparation position, and preparing the lead edge of the third paper web for a splice on the upstream splicer carriage, with transition of this splicer carriage to the ready to splice position on the tandem splicer; then
(5) chucking-up a paper roll associated with a fifth order on the roll stand arms at the upstream end of the primary splicer and preparing the leading edge of a fifth paper web on the fifth roll for future threading and splice preparation on the upstream splicer carriage of the primary splicer; then
(6) initiating the sequence of splicing in the short orders by splicing the second paper web from the second paper roll at the downstream position of the tandem splicer by initiating a splice on the primary splicer to the expiring first paper web; then
(7) continuing the sequence of splicing in short orders by splicing in the third paper web from the third paper roll at the upstream position of the tandem splicer by initiating a splice on the tandem splicer to the second paper web, and
(8) commencing with the splice of step (6), removing the first paper web butt roll from the downstream roll stand arms of the primary splicer, chucking up a fourth paper roll that will provide the fourth paper web to be spliced into the short order sequence, and preparing the leading edge of the paper web from the fourth roll in the downstream splicer carriage of the primary splicer in the splice preparation position, then
(9) splice in the paper web from the fourth roll from step (8) to the third paper web in the primary splicer for the third in the sequence of short orders, and
(10) commencing with the splice of the fourth roll in step (9), positioning the splicer carriage at the upstream end of the primary splicer in its splice preparation position, threading the paper web from the fifth roll previously mounted on the roll stand arms at this position through the splicer carriage and preparing the fifth roll web for a splice, then
(11) splice in the fifth paper roll for a longer fifth order run and prepared for splice in step(10) to the fourth roll, then
(12) position another roll at the roll stand arms on the downstream end of the primary splicer, preparing it for splice and splicing it into the fifth roll to return to step (1).

2. A method for serially splicing three short order paper webs on a corrugator wet end process between a longer first order running downstream web from a first roll and a scheduled longer fifth order web, the method comprising the steps of:
positioning a primary web splicer to directly feed the running wet end process and a tandem web splicer to selectively feed a paper web from second and third rolls for the second order and the third order to the primary splicer;
providing each splicer with an upstream and a downstream splicer carriage, each carriage movable between a splice preparation position at one end of the splicer and a splice position with the carriages centered on the splicer, and a roll stand associated with each splicer to provide a web from a selected one of two web rolls on each roll stand;
providing a pathway including an auxiliary splice preparation platform between the splicers for routing a paper web from one of the rolls on the roll stand for the tandem splicer through the output end of the tandem splicer and into the upstream carriage of the primary splicer, the pathway not interfering with the operator's ability to prepare a splice on the upstream end of the primary splicer;
chucking-up the second and third rolls on the tandem roll stand associated with the first and second short orders, preparing the webs from the second and third rolls on the tandem roll stand for splicing, including threading the first of the webs from the tandem roll stand through the tandem splicer and the pathway to the upstream carriage of the primary splicer in the splice preparation position, while the longer first order is running from the first roll on the primary splicer;
chucking-up a fifth paper roll on the roll stand arms at the upstream end of the primary splicer;
when the longer first order is complete, successively splicing in the second and third webs from the tandem roll stand in the primary splicer and tandem splicer, respectively, to provide the first and second short orders;
removing the butt roll for the longer first order;
replacing the first order roll with a fourth roll and chucking up the fourth roll on the downstream roll arms of the primary splicer,
preparing the fourth roll web for splice on the downstream carriage of the primary splicer;
splicing the fourth roll web on the primary splicer to the end of the second of the webs from the tandem roll stand to provide the third short order web;
preparing the fifth roll web for threading and splice preparation on the upstream carriage of the primary splicer; and
splicing the fifth web to the end of the fourth roll web to be the scheduled longer fifth order.

3. The method as set forth in claim 2, including the step of providing the auxiliary splice preparation platform with a web path that carries the web along the pathway from the tandem splicer downwardly to an operative position below the roll stands, under the position for the upstream roll of the primary splicer, and upwardly to the upstream carriage of the primary splicer.

4. The method as set forth in claim 2, including the step of providing the auxiliary splice preparation platform with a modified web path that carries the web along the pathway from the tandem splicer generally horizontally over the position of the upstream roll of the primary splicer, and to the upstream carriage of the primary splicer.

5. The method as set forth in claim 2, wherein the threading step comprises utilizing the downstream roll from the tandem roll stand for the first of said webs.

6. A method for serially splicing three short order paper webs on a corrugator wet end process between a longer first order running downstream web from a first roll and a scheduled longer fifth order web, the method comprising the steps of:
positioning a primary web splicer to directly feed the running first wet end process and a tandem web splicer to selectively feed a paper web from second and third rolls for the second order and the third order to the primary splicer;
providing each splicer with an upstream and a downstream splicer carriage, each carriage movable between a splice preparation position and a splice position, and a roll stand associated with each splicer to provide a web from a selected one of two web rolls on each roll stand;
providing each of the splicers with paper roll splice functions and paper roll accelerating functions;
providing a pathway including an auxiliary splice preparation platform between the splicers for routing a paper web from one of the rolls on the roll stand for the tandem splicer through the output end of the tandem splicer and into the upstream carriage of the primary splicer, the pathway not interfering with the operator's ability to prepare a splice on the upstream end of the primary splicer;
chucking-up the second and third rolls on the tandem roll stand associated with the first and second short orders, preparing the webs from the second and third rolls on the tandem roll stand for splicing, including threading the first of the webs from the tandem roll stand through the tandem splicer and the pathway to the upstream carriage of the primary splicer in the splice preparation position, while the longer first order is running from the first roll on the primary splicer;
when the longer first order is complete, successively splicing in the second web from the tandem roll stand in the primary splicer using the splicer function in the primary splicer and using the paper roll accelerating function of the tandem splicer, and then splicing the third web from the tandem roll stand using the splicing functions and paper roll accelerating functions of the tandem splicer to provide the first and second short orders;
replacing the first order roll with a fourth roll on the downstream roll arms of the primary splicer,
preparing the fourth roll web for splice on the downstream carriage of the primary splicer;
splicing the fourth roll web to the end of the second of the webs from the tandem roll stand to provide the third short order web;
preparing a fifth roll web on the upstream roll stand arms of the primary splicer for threading and splice preparation on the upstream carriage of the primary splicer; and
splicing the fifth web to the end of the fourth roll web to provide the scheduled longer fifth order.

7. The method as set forth in claim 6, comprising the steps of:
performing he splice functions using a stop bar, cut-off knife and splice sealing rolls of the primary splicer; and,
performing the paper roll accelerating functions using a capstan roll, dancer system and roll brake control of the tandem splicer.

8. The method as set forth in claim 6, including the step of mounting the auxiliary splice preparation platform on a vertical track for movement between an operative lower position providing a preparation position for the operator and an upper running position for the web.

9. The method as set forth in claim 8, including the steps of:
directing the web around an outboard idler roll at the upstream end of the pathway and then downwardly around a pair of platform supporting idler rolls carried on the platform and movable therewith between the lower and upper positions.

10. An apparatus for serially splicing three short order paper webs on a corrugator wet end process between a longer first order running downstream web from a first roll and a scheduled longer fifth order web, the apparatus comprising:
a primary web splicer positioned to directly feed the running first wet end process and a tandem web splicer positioned to selectively feed a paper web from second and third rolls for the second order and the third order to the primary splicer;
each splicer having an upstream and a downstream splicer carriage, each carriage movable between a splice preparation position and a splice position, and a roll stand associated with each splicer to provide a web from a selected one of two web rolls on each roll stand;
each of the splicers having a paper roll splicing arrangement and a paper roll accelerating arrangement;
a pathway including an auxiliary splice preparation platform mounted between the splicers and operative to route a paper web from one of the rolls on the roll stand for the tandem splicer through the output end of the tandem splicer and into the upstream carriage of the primary splicer, the pathway not interfering with the operator's ability to prepare a splice on the upstream end of the primary splicer;
a splicer control operative upon completion of the longer first order to successively splice in the second web from the tandem roll stand in the primary splicer using the splicing arrangement of the primary splicer and the paper roll accelerating arrangement of the tandem splicer, and then to splice the third web from the tandem roll stand using the splicing arrangement and paper roll accelerating arrangement of the tandem splicer to provide the first and second short orders;
the splicer control apparatus operative to splice the web from a fourth roll on the primary splicer to the end of the second of the webs from the tandem roll stand to provide the third short order web, and to splice a fifth web to the end of the fourth roll web to be the scheduled longer fifth order.
